(19) United States
(12) Patent Application Publication
(10) Pub. No.: US 2010/0154189 A1
(43) Pub. Date: Jun. 24, 2010

(54) Pop-Ette beverage can opener

(76) Inventor: John Charles Smith, Norristown, PA (US)

Correspondence Address: RUTH EURE, 4795 EDISON AVENUE, BOULDER, CO, 80301, US

(21) Appl. No.: 12/655,078

(22) Filed: Dec. 22, 2009

Related U.S. Application Data
(60) Provisional application No. 61/203,496, filed on Dec. 22, 2008.

(51) Int. Cl. B67B 7/40; B67B 7/00

(52) U.S. Cl. 29/426.4; 81/3.55

(57) ABSTRACT

The present invention, referred to herein as the Pop-Ette, is a unique tool that is specially designed for opening the “pop-tops” of aluminum cans. The present invention provides a beverage can opener, comprising an elongate durable plastic handle measuring approximately 4″ in length, further comprising a metal extension extending from the distal end of the handle, wherein the metal extension extends in a curved fashion, culminating in a tapered end having a lateral width of approximately ¼ inch. The tool of the present invention features a durable plastic handle to ensure a comfortable grip.

### CLAIM OF PRIORITY

This patent application claims priority under 35 USC 119 (e) (1) from U.S. Provisional Patent Application Ser. No. 61/203,496 filed Dec. 22, 2008, of common inventorship herewith entitled, “POP-ETTE Beverage Can Opener.”

### FIELD OF THE INVENTION

The present invention pertains to the field of can openers and more specifically to the field of beverage can openers.

### BACKGROUND OF THE INVENTION

The prior art has put forth several designs for openers of beverage cans. These include:

U.S. Pat. No. 3,459,075 to H. E. Henderson describes a can opener comprising a pronged hook for engaging and lifting the pop top of a beverage can.

U.S. Pat. No. 4,287,794 to John S. and Elizabeth V. Kuback describes a container opening tool having a multiplicity of projecting members and hooks for engaging a multiplicity of can openings.

U.S. Pat. No. 4,719,824 to Robert Chagoya describes a puyll tab opener comprising a hinged device for engaging the rim of the can to be opened.

None of these prior art devices describe the present invention.

### SUMMARY OF THE INVENTION

It is an object of the present invention to provide a deice for easy opening of a beverage can having a pop top opening.

### BRIEF DESCRIPTION OF THE DRAWINGS

FIG. 1 shows a perspective view of the beverage can opener of the present invention.

FIG. 2 shows a perspective view of the beverage can opener of the present invention engaging a pop top of a beverage can.

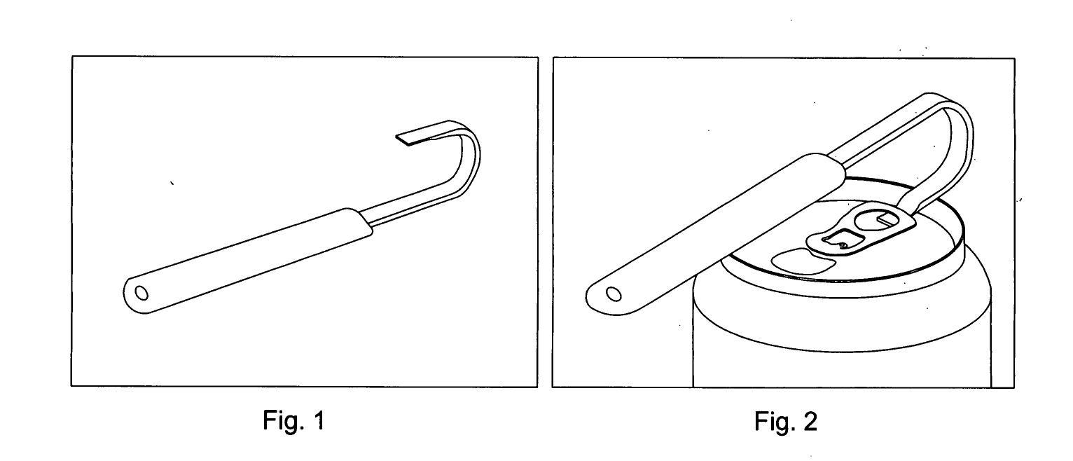

### DETAILED DESCRIPTION OF THE INVENTION

Aluminum cans are used for soda pop, beer, juices, coffee milk drinks and other dairy-based beverages. Naturally lightweight, these cans provide shelf stability and protection from external factors including ultraviolet (UV) light and gases. However, with all the practicality and convenience of aluminum cans, their use is not without a drawback. To ensure airtight closure so that carbonation and other flavorings do not escape, aluminum cans are diligently sealed, and only accessible via a “pop-top” opening. However, mastering this aspect of can packaging can prove quite challenging. Most often, the tab that serves to break the beverage seal is so flush against the top of the can that one has to wrestle with it to release it. Ladies with long fingernails typically have an advantage when it comes to opening a soda or beer can, but they run the risk of painfully breaking their nails attempting to pop these high tensiled tops.

The present invention provides a practical invention that offers a convenient solution to the aforementioned challenge. The present invention, referred to herein as the Pop-Ette, is a unique tool that is specially designed for opening the “pop-tops” of aluminum cans. The present invention provides a beverage can opener, comprising an elongate durable plastic handle measuring approximately 4″ in length, further comprising a metal extension extending from the distal end of the handle, wherein the metal extension extends in a curved fashion, culminating in a tapered end having a lateral width of approximately ¼ inch.

The tool of the present invention features a durable plastic handle to ensure a comfortable grip. At the distal end of the handle, a metal apparatus extends in a curved fashion, culminating in a tapered end with a lateral width of approximately ¼ inch. Simple in design yet effective in application, use of the Pop-Ette is very easy and straightforward. Much like a bottle opener, the metal, tapered end of this tool is placed underneath the tab of an aluminum can. With a simple pull in an upward direction, the tab easily lifts from the can and immediately breaks the seal of the container. As a result, a user is enabled to immediately enjoy the beverage of choice, whether it is a crispy-tasting Mountain Dew, an ice cold can of Budweiser, or an energy boosting Red Bull, with expedience and ease. Eliminating time consuming wrestling with pop-tops and moreover, the possibility of breaking an elegantly polished finger-nail, the Pop-Ette provides an invaluable addition to any household or business.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A beverage can opener, comprising an elongate durable plastic handle measuring approximately 4″ in length, further comprising a metal extension extending from the distal end of the handle, wherein the metal extension extends in a curved fashion, culminating in a tapered end having a lateral width of approximately ¼ inch.

2. A method of opening a beverage can comprising:
placing the metal, tapered end of this tool is placed underneath the tab of an aluminum can;
pulling the tool in an upward direction, thereby easily lifting the tab from the can and immediately breaking the seal of the can.
